(19) United States
(12) Patent Application Publication
(10) Pub. No.: US 2014/0102433 A1
(43) Pub. Date: Apr. 17, 2014

(54) MAGNETIZED PICK AXE AND METHOD OF FORMING SAME

(71) Applicant: ROBERT RIECK, Mission Viejo, CA (US)

(72) Inventor: ROBERT RIECK, Mission Viejo, CA (US)

(21) Appl. No.: 13/653,243

(22) Filed: Oct. 16, 2012

(51) Int. Cl. B28D 1/26; B23P 15/28

(52) U.S. Cl. CPC B28D 1/26; B23P 15/28
USPC 125/43; 76/109

(57) ABSTRACT

A pick axe is provided with recesses formed in the concave surfaces of its pick and its blade which are then filled with adhesive into which corresponding magnetic slugs are then bedded. The adhesive is faired with the adjacent surfaces around each recess and once set up or cured fully encapsulates the magnetic slug within its larger recess to isolate the higher frequency, or the higher energy components of each pick axe impact to protect the received slugs from demagnetization and/or fracture.

### REFERENCE TO RELATED APPLICATIONS

None.

### STATEMENT CONCERNING GOVERNMENT INTEREST

None.

### BACKGROUND OF THE INVENTION

1. Field of the Invention

The present invention relates to prospecting devices, and more particularly to pick axes in which magnetic inserts are resiliently deployed in protective recesses to minimize their demagnetization by repeated impacts.

2. Description of the Prior Art

Those engaged in precious metal prospecting, and particularly those prospecting for gold, very often use metal detectors in order to assist in this very tedious task. The typical prospected site, however, is very often heavily cluttered by iron deposits and/or buried iron articles or tools left by others that mask by their false signals any potential detection of the much more scarce deposits and until these items or deposits are first extracted and removed little efficacy is obtained from the metal detection process. This loss of detection efficacy has been particularly burdensome when the prospected site consists mainly of hardened or well compacted layers that consume substantial physical effort in the course of their penetration and fracturing.

In the past rakes that incorporate magnetized tines have been devised to handle the tedious extraction and separation burden of the ferrous articles and deposits from the remaining material that was thereafter scanned by electronic detection, exemplified by the teachings of U.S. Pat. No. 5,429,402 to Kennedy; U.S. Pat. No. 7,331,470 to Vernon et al.; U.S. Pat. No. 8,157,101 to Arnold; and many others. While suitable for the purposes intended, the full utility of a rake is only obtained after the prospected ground is first fully fractured and fragmented, a physical state that is reached only by substantial physical efforts. Additionally, a rake is less than a perfect tool for reaching and extracting deposits collected in various crevasses or pockets, an state that is particularly associated with prospecting for gold and silver deposits and for these reasons one finds the ubiquitous pick axe amongst virtually all of the prospectors' tool collections.

A pick axe, characteristically, is associated with heavy, high energy spectra, repeating impacts which are usually transmitted in their full spectrum to demagnetize any magnetic piece that may be fixed to the pick axe blade or spear and it is this inherent demagnetization that has limited the number of successful prior art examples thereof. Of the few examples of a magnetized pick axe that are commercially available the most prevalent commercially vended pick axe structures are those sold by Apex Picks, Boise, Id. under the model designation ‘Extreme’, part no. GC1245-8, characterized by a set of tubular collars welded to the axe blade exterior to axially extend in cantilever therefrom in which circular magnetic slugs are then inserted and magnetically retained, or the pick axe sold under the mark or style ‘Mag-na-pick’ by JW's Prospecting Supplies, 6426 E. Highway 69, Prescott, Ariz. 86314, characterized by a magnet that is bedded directly in the handle end.

While suitable for the purposes intended, the configuration of the first commercial example is such that surface of each of the cantilevered collars projects beyond the surface of the pick or the adze blade and thus exposes the magnetic slug held therein to repeated demagnetizing impacts against the hard ground that is being worked, while the handle centered location of the second example results in a reduction in the magnetic strength at the working surfaces of the pick axe head. A mounting arrangement for the magnetizing inserts that maximizes the magnetic strength by its locations within the pick axe blades and that also attenuates the higher frequency, and therefore the higher energy, spectra associated with each impact while also shielding the insert from direct opposing contact, is therefore extensively desired and it is one such mounting that is disclosed herein.

### BRIEF SUMMARY OF THE INVENTION

Accordingly, it is the general purpose and object of the resent invention to provide one or more circular recesses that partly extend into the interior surface of a curved pick axe blade dimensioned to receive in resilient mounting conforming magnetic inserts that then magnetize the working portions of the pick axe head.

Other and further objects of the present invention shall become apparent upon the examination of the description that follows in association with the illustrations appended.

Briefly, these and other objects are accomplished within the present invention by providing one or more circular recesses formed within the thickness of the pick or spear and also the blade or adze of the pick axe head each extending from an opening in the corresponding inside surfaces of the adze and also the pick structure to form a generally circular pocket therein of a planform and depth just greater than the corresponding diameter and thickness of a circular magnetic slug that is receivable therein. Preferably, each of the received magnetic slugs is of the higher magnetic strength rare earth alloy, such as the neodymium alloy, that is characterized by its tendency to corrode and a very brittle structure and is therefore clad or plated on its exteriors by a coating of nickel or some of the more noble alloys. To protect this brittle and corrosion prone magnetic waver or slug and to isolate it from the impact shocks that are inherent in the use of a pick axe the receipt thereof in the corresponding pocket is imbedded in an elastic interface.

More precisely, the process of insertion of each of the slugs in their appropriate pockets includes a process in which each receiving circular pocket is first coated with an elastomeric adhesive such as polyurethane, flexible polyvinyl chloride (PVC), or even a catalyzed mix of one of the more elastic polyester resins, with the corresponding slug then betted therein and thereafter covered by its excess that is smoothed and faired to conform with the surrounding surface. Once the elastomer cures the finished pick axe is then ready for its robust use.

### BRIEF DESCRIPTION OF THE DRAWINGS

FIG. 1 is a perspective illustration of a prior art magnetized pick axe useful in removing iron articles and deposits from a prospected site;

FIG. 2 is yet another perspective view, separated by parts, illustrating the inventively magnetized pick axe in the course of the assembly thereof;

FIG. 3 is a further perspective illustration of the inventively magnetized pick axe in its fully assembled form; and

FIG. 4 is a sectional view taken along line 4-4 of FIG. 3.

### DESCRIPTION OF THE PREFERRED EMBODIMENT

As shown in FIG. 1 a typical configuration of a prior art pick axe PA is characterized by an iron, and thus ferromagnetic, steel axe head AH including a generally central opening or eye EY in which the forward end of a wooden shaft or handle HA is received. Eye EY, in turn, supports on one of its sides a spear or pick PI of an elongate, generally conical, configuration extending to form a generally arcuate structure terminating in a point of an arc defined by the manual swinging of the handle AH to develop sufficient energy to drive the pick into the ground. A similarly arched blade or adze AD on the opposite side of the eye EY is then useful to further cut and fracture the ground that was earlier penetrated by the pick. Thus by their defining shapes both the working ends of the pick axe PA absorb repeated impacts against the ground with the impact energy at the end of each swing directly determined by the compaction and hardness of the ground.

In an effort to utilize more efficiently these repeated swings of the pick axe, and more particularly to remove from the fractured ground all the iron deposits and whatever buried iron debris that by its presence swamps the signals of a metal detector, the above prior art pick axe structure often also includes a set of rings or collars RC that are each spot welded at one of their edges to the exterior of the adze and the pick into which corresponding magnetic slugs or wavers SL are then inserted and magnetically retained. One example of a pick axe thus implemented is sold by Apex Picks, Boise, Id. under the model designation ‘Extreme’, part no. GC1245-8. Of course, the general structure of the pick axe of the other commercially available variants that deploy the magnetizing slug in the end of the handle is similarly implemented.

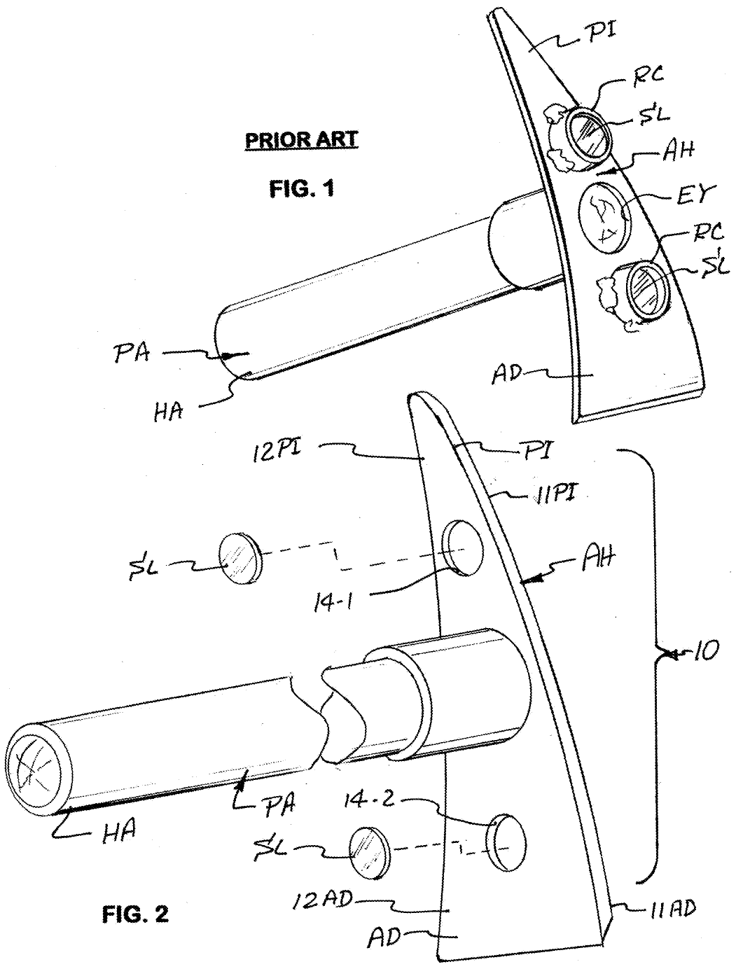

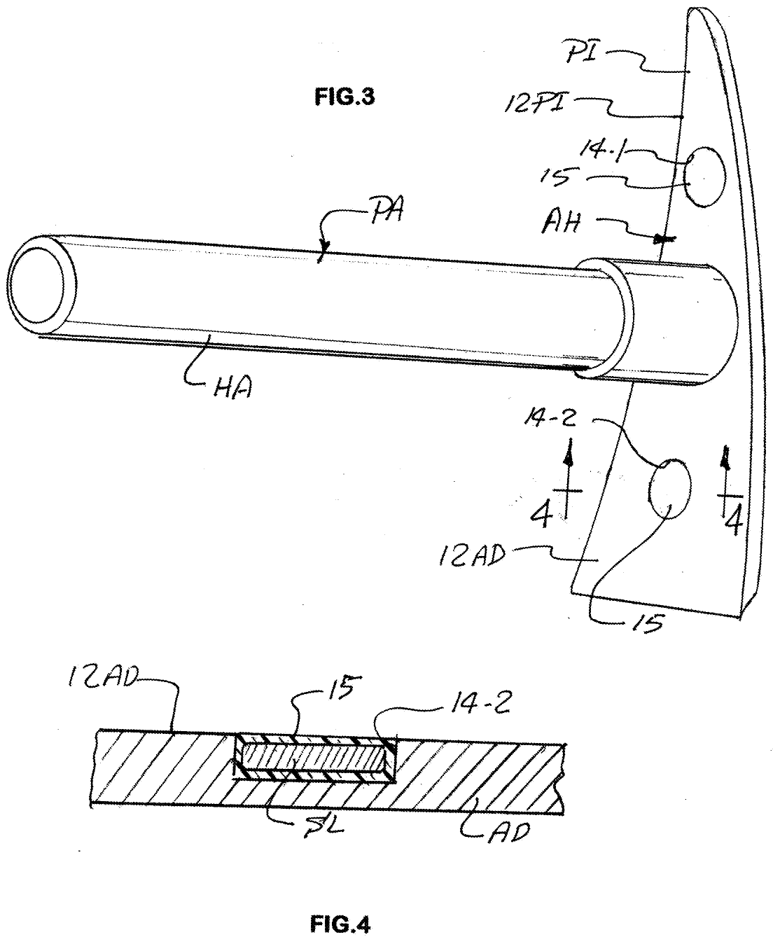

By particular reference to FIGS. 2 through 4 the preferred embodiment of the inventive pick axe structure, generally designated by the numeral 10, is once again generally formed as a conventional pick axe PA defined by an axe head AH engaged to the end of a handle HA fitted within its central eye EY from which a generally conical pick PI and an oppositely directed blade or adze AD project. In accordance with the swing dynamics of this structure both the pick PI and the adze AD are arched in their cantilevered opposing projection from the eye EY with their arcuate forms respectively defined by an exterior, convex surfaces 11PI and 11AD and interior, concave surfaces 12PI and 12AD, with the incidence of direct impact being much less frequent on the interior, concave surfaces in the course of the usual use of the pick axe PA.

This impact preference is utilized to an advantage within the present invention by forming one or more inwardly directed circular recesses 14-1 and 14-2 that extend through the corresponding surfaces 12PI and 12AD partly into the thickness of the pick PI and the adze AD, with the diameter of each of these recesses being fractionally larger than the diameter of the magnetic wafers or slugs SL and the depth of each recess is fractionally greater than the thickness of the slugs SL that are insertable therein. More particularly, each of the recesses 14-1 and 14-2 is first partly filled with the resilient potting compound 15 like Loctite Number 609 sold by Ellworth Products, W′129 N10825 Washington Dr., Germantown, Wis. 53022, or one of the several adhesives of polyurethane, flexible polyvinyl chloride (PVC), or a catalyzed mix of one of the more elastic polyester resins, with the slugs SL then immersed therein before the compound is cured and the compound surface then faired to conform with the surrounding shape.

In this form each of the inserted slugs SL is shielded from the higher energy (i.e., higher frequency spectrum) of each impact, both circumferentially and across its thickness in a structural arrangement that allows for convenient removal of the softer potting compound and the magnet replacement right in the field should it be demagnetized or otherwise damages. Thus the heavier parts of the pick axe assembly do not need duplication with redundancy obtained by easily carried and conveniently installed lightweight replacement complements.

Significantly, this same exact installation and replacement process also results in a mounting of the fragile and easily demagnetized magnet that is fully bedded along the planes of the major impacts within the resilient potting compound cushion fixed in the rugged pick axe structure. This fully confined structural arrangement that inherently dissipates the higher frequency, and thus higher energy, components of the periodic impacts, either by friction or hysteresis, is particularly effective at the slow repetition rate of a manual process. The bedding combination therefore elegantly resolves the frustrating aspects of this very tedious endeavor.

Obviously many modifications and variations of the instant invention can be effected without departing from the spirit of the teachings herein. It is therefore intended that the scope of the invention be determined solely by the claims appended hereto.

It is claimed:

1. In a pick axe assembly characterized by a ferromagnetic axe head mounted at one end of an elongate handle and defined by a generally orthogonally deployed pick and an opposing blade, each extending from said handle in opposing arcuate segments, the improvement comprising:
a recess extending partly into the interior of said axe head;
a magnet received in said recess; and
polymeric mounting means interposed between said magnet and said recess.

2. Apparatus according to claim 1, wherein:
said magnet is generally circular in planform; and
said recess includes a circular opening having a radial dimension greater than said circular planform of said magnet.

3. Apparatus according to claim 2, wherein:
said magnet is of a thickness that is less than the depth of said recess.

4. Apparatus according to claim 3, wherein:
said polymeric mounting means includes a polymeric potting compound.

5. Apparatus according to claim 3, wherein:
said polymeric mounting means includes a polymeric adhesive selected from a group including polyurethane, flexible polyvinyl chloride and catalyzed mix of polyester resins.

6. In a pick axe assembly characterized by a ferromagnetic axe head mounted at one end of an elongate handle and defined by a generally orthogonally deployed arcuate pick and an opposing arcuate blade each deployed to align the concave portion thereof towards said handle, the improvement comprising:
a recess extending through each said concave portion partly into the interior of said pick and said blade;
a magnet received in each said recess; and
polymeric mounting means interposed between said magnet and said recess.

7. Apparatus according to claim 6, wherein:
said magnet is generally circular in planform; and
each said recess includes a circular opening having a radial dimension greater than said circular planform of said magnet.

8. Apparatus according to claim 7, wherein:
said magnet is of a thickness that is less than the depth of each said recess.

9. Apparatus according to claim 8, wherein:
said polymeric mounting means includes a polymeric potting compound.

10. Apparatus according to claim 8, wherein:
said polymeric mounting means includes a polymeric adhesive selected from a group including polyurethane, flexible polyvinyl chloride and catalyzed mix of polyester resins.

11. A method for magnetizing a pick axe characterized by a ferromagnetic axe head mounted at one end of an elongate handle and defined by a generally orthogonally deployed arcuate pick and an opposing arcuate blade each deployed to align the concave portion thereof towards said handle, comprising the steps of:
forming a recess extending through each said concave portion partly into the interior of said pick and said blade;
depositing a polymeric adhesive into each said recess; and
inserting a magnet in each said recess.

12. A method according to claim 11, wherein:
said step of depositing a polymeric adhesive includes adhesives selected from a group including polyurethane, flexible polyvinyl chloride and catalyzed mix of polyester resins.
